(19) United States
(12) Patent Application Publication
(10) Pub. No.: US 2009/0047003 A1
(43) Pub. Date: Feb. 19, 2009

(54) PLAYBACK APPARATUS AND METHOD

(75) Inventor: Koichi Yamamoto, Yokohama-shi (JP)

Correspondence Address: Charles N.J. Ruggiero, Esq.;Ohlandt, Greeley, Ruggiero & Perle, L.L.P., 10th Floor, One Landmark Square, Stamford, CT, 06901-2682, US

(73) Assignee: Kabushiki Kaisha Toshiba

(21) Appl. No.: 12/046,693

(22) Filed: Mar. 12, 2008

(30) Foreign Application Priority Data
Aug. 14, 2007 (JP) 2007-211447

(51) Int. Cl. H04N 5/00

(52) U.S. Cl. 386/126

(57) ABSTRACT

A playback apparatus used for an audio database includes a first acquisition unit configured to acquire first position information and second position information, an estimation unit configured to estimate a required period from a first position to a second position based on the first position information and the second position information, a second acquisition unit configured to acquire a data length of an audio signal to be played back from the audio database, a determination unit configured to determine a playback speed required to play back the audio signal based on the required period and the data length to complete playback of the audio signal within the required period, and a playback unit configured to play back the audio signal according to the playback speed.

### CROSS-REFERENCE TO RELATED APPLICATIONS

This application is based upon and claims the benefit of priority from prior Japanese Patent Application No. 2007-211447, filed Aug. 14, 2007, the entire contents of which are incorporated herein by reference.

### BACKGROUND OF THE INVENTION

1. Field of the Invention

The invention relates to a playback apparatus and method, which play back an input audio signal by companding its time axis.

2. Description of the Related Art

Conventionally, a playback apparatus such as a DVD player or the like comprises a time axis companding function which realizes efficient listening and viewing by compressing the time axis of an input signal. The time axis companding processing extracts feature amounts such as a fundamental frequency and the like from an input signal, and realizes a desired playback speed by inserting or deleting a signal having an adaptive time width which is determined based on the extracted feature amounts. As a typical time axis companding method, PICOLA is known (for example, see JP-A 2003-309814 (KOKAI), and Naotaka Morita and Fumitada Itakura, “Time-Scale Modification Algorithm for Speech by Use of Pointer Interval Control Overlap and Add (PICOLA) and Its Evaluation”, 3-1-2 Proc. ASJ Conf., October 1986, p. 149-150). This scheme attains temporal companding processing by extracting a fundamental frequency from an input signal, and repeating insertion and deletion of a waveform for the extracted fundamental frequency.

Such playback apparatus with the time axis companding function need determine the playback speed so as to compand a target audio signal to a desired time duration. At this time, the related art determines the playback speed based on a designation from the user or a fixed value given by a system.

However, the conventional scheme cannot determine an optimal playback speed upon playing back an audio signal to be played back within a period (to be referred to as “within a playback required period” hereinafter) that can be spent for playback. For example, assume that the user wishes to complete playback of a DVD by the time he or she reaches a destination upon playing back a movie or the like using the DVD player of a car navigation system. With the aforementioned conventional playback speed determination method, the user himself or herself has to determine the playback speed, thus posing the following problems. That is, upon selection of an excessively high playback speed at times, such speed disturbs listening. Upon selection of a low playback speed at other times, such speed cannot complete playback of a target audio signal within a playback required period.

As a conventional scheme, a method of determining a playback speed according to a user profile which registers attribute information such as an age, use language, audibility against fast audio playback, and the like in association with an individual user who uses the playback apparatus has been proposed (for example, see JP-A 2003-309814).

However, this scheme is not designed to determine the playback speed in terms of playback of an audio signal within the playback required period, and the problem that the playback of a target audio signal cannot be completed within the playback required period cannot be solved.

As described above, the related arts cannot select an optimal playback speed upon time axis companding playback of an audio signal, thus posing the following problems. That is, upon playback at an excessively high speed at times, such speed disturbs listening of the audio signal. Upon playback at a low speed at other times, such speed cannot complete playback of a target audio signal within the playback required period.

### BRIEF SUMMARY OF THE INVENTION

In accordance with a first aspect of the invention, there is provided a playback apparatus used for an audio database comprising: a first acquisition unit configured to acquire first position information and second position information; an estimation unit configured to estimate a required period from a first position to a second position based on the first position information and the second position information; a second acquisition unit configured to acquire a data length of an audio signal to be played back from the audio database; a determination unit configured to determine a playback speed required to play back the audio signal based on the required period and the data length to complete playback of the audio signal within the required period; and a playback unit configured to play back the audio signal according to the playback speed.

In accordance with a second aspect of the invention, there is provided a playback apparatus used for an audio database comprising: a first acquisition unit configured to acquire an audio signal to be played back from the audio database; a discrimination unit configured to discriminate intervals for respective acoustic classes included in the audio signal; a calculation unit configured to calculate data lengths for respective intervals; a second acquisition unit configured to acquire first position information and second position information; an estimation unit configured to estimate a required period from a first position to a second position based on the first position information and the second position information; a determination unit configured to determine a plurality of playback speeds required to play back the audio signal for respective intervals based on the required period and the data lengths for respective intervals to complete playback of the audio signal within the required period; and a playback unit configured to play back the audio signal according to the playback speeds.

### BRIEF DESCRIPTION OF THE SEVERAL VIEWS OF THE DRAWING

FIG. 1 is a block diagram showing a playback apparatus according to the first embodiment;

FIG. 2 shows an example of playback means of a playback unit shown in FIG. 1;

FIG. 3 is a block diagram showing a playback apparatus according to the second embodiment; and

FIG. 4 shows an example of speech and non-speech intervals discriminated by a discrimination unit shown in FIG. 3.

### DETAILED DESCRIPTION OF THE INVENTION

A playback apparatus and method according to embodiments of the invention will be described in detail hereinafter with reference to the accompanying drawings. In the embodiments to be described hereinafter, assume that parts denoted by the same reference numerals perform the same operations, and a repetitive description thereof will be avoided. The embodiments especially assume an in-vehicle navigation system, but the embodiments are not limited to such specific case.

According to the playback apparatus and method of the embodiments, an optimal playback speed upon playing back an audio signal within the playback required period can be determined.

### First Embodiment

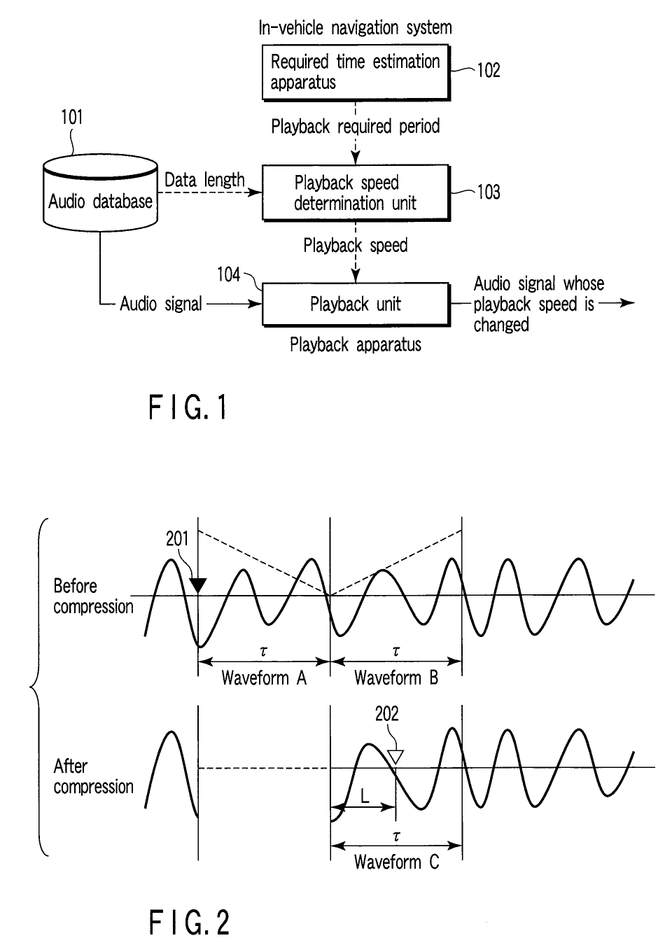

A playback apparatus according to the first embodiment will be described below with reference to FIG. 1.

The playback apparatus of this embodiment includes an audio database 101, required time estimation apparatus 102, playback speed determination unit 103, and playback unit 104.

The audio database 101 contains audio signal data to be played back by the playback unit 104. The audio database 101 contains, for example, a plurality of audio signal datasets in correspondence with a plurality of video signal datasets.

The required time estimation apparatus 102 acquires the position information of the present location and that of a destination of an object in motion, and estimates a required period from the current position until arrival at the destination based on these pieces of information. The required time estimation apparatus 102 estimates a required period (to be referred to as an estimated required period hereinafter) until arrival at a destination based on, e.g., the current position of a vehicle acquired from a GPS, the position information of the destination designated by the user, a traveling velocity of the vehicle, and the like.

The playback speed determination unit 103 acquires the data length of an audio signal, and the estimated required period estimated by the required time estimation apparatus 102, and determines a playback speed to be designated in the playback unit based on the data length and the required period. The playback speed determination unit 103 acquires this estimated required period as a playback required period of the audio signal. Note that the data length of the audio data is that from the leading end to the terminal end upon normal playback (1.0× speed) of an audio signal to be played back. When an audio signal is divided into a plurality of tracks, a total value of the data lengths of tracks selected by the user may be used.

The playback unit 104 inputs recorded audio signal data from the audio database 101, and plays back an audio signal by changing a playback speed according to the playback speed designated by the playback speed determination unit 103.

An example of the operation of the playback apparatus shown in FIG. 1 will be described below.

The playback speed determination unit 103 acquires the data length of an audio signal to be played back from the audio database 101. The acquisition format of the data length is desirably a time duration like “XX seconds” in consideration of consistency with the playback required period to be described later.

The playback speed determination unit 103 acquires the playback required period that can be spent for playback of the audio signal to be played back from the required time estimation apparatus 102. The required playback period can be calculated as an estimated required period as a result of simple division of the distance from the current location to the destination of a vehicle by an average velocity. Using the VICS (Vehicle Information and Communication System), an average velocity that reflects the traffic condition may be received, and the arrival time may be estimated using that average velocity. The playback speed determination unit 103 acquires the estimated required period from the navigation system as a playback required period of the audio signal. At this time, in order to allow the user to complete playback of the audio signal in good time, the playback required period may be set to have a time duration shorter than the estimated required period.

The playback speed determination unit 103 determines a playback speed based on the acquired data length of the audio signal and the acquired playback required period, so as to complete playback of the audio signal within the playback required period. Let T be the data length of the audio signal, and Y be the playback required period. Then, a playback speed P is determined by P=T/Y. By playing back the audio signal at the playback speed P, playback of the audio signal to be played back can be completed within the playback required period. Details of the processing of the playback speed determination unit 103 will be described later.

The playback speed P determined by the playback speed determination unit 103 is transmitted to the playback unit 104 which compands the time duration of the audio signal. The playback unit 104 converts the playback speed of the input audio signal based on the playback speed P. Details of the processing of the playback unit 104 will be described later with reference to FIG. 2.

(Playback Speed Determination Method)

The playback speed determination method of the playback speed determination unit 103 will be described in detail below.

As described above, the playback speed P is determined by P=T/Y based on the relationship between the data length T of the audio signal to be played back and the playback required period Y. However, in order to provide a more comfortable listening condition to the user, given limitations may be imposed on updating of the playback speed, and its range.

<Playback Speed Updating Width>

Control of the updating width of the playback speed will be described first. The playback apparatus of this embodiment is connected to an in-vehicle navigation system, and the estimated required period until arrival at a destination may change owing to a change in traveling condition due to traffic jam or the like and switching of the destination. In this case, the reproduction apparatus of this embodiment updates the playback speed according to a change in estimated required period. At this time, the apparatus can control so that a change (difference) in playback time per unit time before and after updating falls within a predetermined range. For example, assume that the speed before updating is 2.0× speed. At this time, when the playback required period changes to 60 minutes, and the remaining data length of the audio signal to be played back changes to 60 minutes, the playback speed P after updating changes to a 1.0× speed.

However, when the playback speed is abruptly switched from the 2.0× speed to the 1.0× speed, the watching user may feel unnatural. Hence, the playback speed determination unit 103 of this embodiment controls a change in playback speed before and after updating to fall within a predetermined range. That is, in case of the aforementioned example, the unit 103 controls to decrease the playback speed by a 0.1× speed per minute without abruptly switching the speed from the 2.0× speed to the 1.0× speed. In this way, the user can avoid unnatural playback due to an abrupt change in playback speed, and can gain a comfortable listening condition. Note that this control can be used when the playback speed changes from a low speed to a high speed. Assume that the playback speed before updating is a 1.0× speed, the playback required period changes to 45 minutes, and the remaining data length of the audio signal changes to 60 minutes. In this case, the unit 103 controls to monotonically increase the playback speed from a 1.0× speed to a 1.5× speed for the first 30 minutes, and to play back the audio signal at a 1.5× speed for the remaining 15 minutes, thus completing playback of the audio signal within the playback required period.

<Playback Speed Setting Range>

Control of the setting range of the playback speed will be described below. This control imposes a given limitation on the range of the playback speed determined by the playback speed determination unit 103. For example, assume that the user or system limits the playback speed in advance to fall within a range from 1.0× to 2.0× speed. At this time, when the playback required period is 60 minutes, and the data length of the audio signal is 30 minutes, the playback speed P is set to be a 1.0× speed as the lower limit value in place of a 0.5× speed given by P=T/Y.

Normally, when the playback required period has a margin (T<Y), the audio signal need only be played back at a 1.0× speed without any expansion processing. Hence, by setting the lower limit of the playback speed to be a 1.0× speed in advance, the audio signal can be avoided from being played back at an excessively lower speed.

On the other hand, a case will be examined below wherein the playback required period is 10 minutes, and the data length of the audio signal is 30 minutes. In this case, the playback speed P is set to be a 3.0× speed given by P=T/Y. In general, when the playback speed is set to be an excessively high speed (e.g., a speed higher than a 2.0× speed), it becomes difficult for the user to understand the contents of the audio signal after high-speed playback. Hence, when the playback speed that exceeds the upper limit has to be set to complete playback of the audio signal within the playback required period, a message that advises accordingly is desirably presented to the user prior to the beginning of playback of the audio signal. In this way, the user can avoid a difficult condition of listening of the audio signal due to an excessive playback speed, and can select another audio signal which can be played back within the playback required period. Note that the setting range of the playback speed can also be switched according to a profile including the age of the user and the like in addition to designation by the user.

(Playback Method)

The playback method of the playback unit 104 will be described below with reference to FIG. 2.

This embodiment will explain a configuration using the PICOLA method as one of the time axis companding methods. With this method, the playback unit 104 processes an audio signal at a companding ratio R=1/P according to the playback speed P obtained from the playback speed determination unit 103. The unit 104 extracts a fundamental frequency τ from the input audio signal. The unit 104 then executes the time axis companding processing of the input signal based on the fundamental frequency τ.

FIG. 2 shows an audio signal upon execution of time axis compression (R<1) by the PICOLA method. The playback unit 104 sets a pointer 201 shown in FIG. 2 at the start position of time axis compression, and extracts the fundamental frequency τ in the audio signal after this pointer. Then, the unit 104 generates a waveform C as a signal obtained by overlap-adding two waveforms A and B for the fundamental frequency τ from the pointer position using crossfading weights. In this case, the waveform C with a length τ is generated by multiplying the waveform A by a weight that changes from 1 to 0 in the direction of the horizontal axis, and the waveform B by a weight which linearly changes from 0 to 1. This crossfading processing is done to maintain continuity at the connection points before and after the waveform C. The unit 104 then shifts the pointer on the waveform C by L=R×τ/(1−R) to set a start pointer 202 in FIG. 2 of the next processing. As can be understood from the above description, the aforementioned processing generates an output waveform with a length L from an input signal with a length L+τ=τ/(1−R), and satisfies the companding ratio R. In this way, the time duration control of the audio signal can be attained according to the playback speed P.

As described above, according to the first embodiment, since the playback speed used in the playback unit is determined according to the playback required period and the data length of an audio signal to be played back, the user can play back the audio signal within the playback required period. Also, an optimal playback speed can be selected depending on the situation, and the problems that the excessively high-speed playback disturbs listening of the audio signal, low-speed playback cannot complete playback of the audio signal within the playback required period, and so forth can be solved.

Note that this embodiment has exemplified the audio signal but can play back video and audio signals. At this time, by inserting a video signal in field units of 1/60 seconds or 1/50 seconds (Hi-Vision, NTSC system: 1/60 seconds, PAL system: 1/50 seconds), the video signal can be synchronized with an audio signal whose playback speed is changed. This embodiment has exemplified the in-vehicle navigation system as the required time estimation apparatus. However, even when the playback apparatus according to the invention is connected to a required time estimation apparatus of an airplane, ship, or the like, the same effects can be expected.

### Second Embodiment

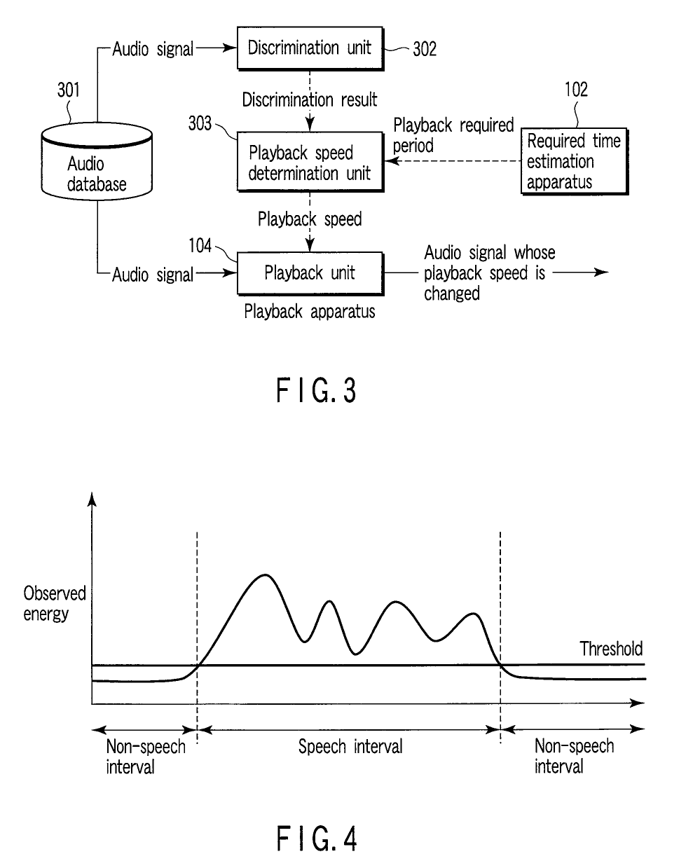

A playback apparatus according to the second embodiment will be described below with reference to FIG. 3.

The playback apparatus of this embodiment includes an audio database 301, a discrimination unit 302, a playback speed determination unit 303, the required time estimation apparatus 102, and the playback unit 104.

The audio database 301 contains audio signal data to be played back by the playback unit 104 like the audio database 101. The audio database 301 outputs an audio signal to the discrimination unit 302 and playback unit 104.

The discrimination unit 302 discriminates an interval for each acoustic class included in the audio signal to be played back. Details of the discrimination unit 302 will be described later with reference to FIG. 4.

The playback speed determination unit 303 calculates a data length for each acoustic class to be played back based on the discrimination result of the discrimination unit 302. The unit 303 acquires, as a playback required period of the audio signal, an estimated required period from the required time estimation apparatus which estimates the required period until arrival at a destination based on the current position of a mobile object and the position information of the destination. The unit 303 then determines a playback speed of each acoustic class based on the data length of each acoustic class and the playback required period, so as to complete playback of the audio signal within the playback required period. Details of the playback speed determination unit 303 will be described later using some mathematical expressions.

The discrimination unit 302 will be described below with reference to FIG. 4. This embodiment will explain a case wherein the discrimination unit 302 discriminates speech and non-speech intervals of an audio signal based on energies.

The discrimination unit 302 calculates the energies of an input audio signal every 20 to 30 ms. The unit 302 compares the obtained energy with a threshold which is set in advance. The unit 302 discriminates an interval where the energy exceeds the threshold as a speech interval, and an interval where the energy is less than the threshold as a non-speech interval.

The speech interval and non-speech interval detected by this method are, for example, as shown in FIG. 4. In addition, a method of determining a speech interval based on two feature amounts, i.e., a likelihood ratio and energy obtained by collating spectrum information of an input signal and speech and non-speech models which are learned in advance has been proposed (see K. Yamamoto, F. Jabloun, K. Reinhard and A. Kawamura, “ROBUST ENDPOINT DETECTION FOR SPEECH RECOGNITION BASED ON DISCRIMINATIVE FEATURE EXTRACTION,” in Proc. ICASSP 2006, May 2006.)

The discrimination unit 302 extracts the leading end positions, terminal end positions, and interval durations of respective acoustic classes based on the discrimination results of the speech and non-speech intervals, as shown in Table 1, and transmits them as discrimination results to the playback speed determination unit 303. Note that when acoustic classes included in an audio signal to be played back are extracted in advance, the discrimination results are transmitted to the playback speed determination unit 303 without executing the discrimination processing in the discrimination unit 302.

TABLE 1

| Leading end | Terminal end | Interval | |
|---|---|---|---|
| position | position | duration | Discrimination |
| (mm:ss) | (mm:ss) | (mm:ss) | result |
| . . . | . . . | . . . | . . . |
| 03:50 | 04:15 | 00:25 | Audio |
| 04:15 | 04:55 | 00:40 | Non-audio |
| 04:55 | 05:10 | 00:15 | Audio |
| . . . | . . . | . . . | . . . |

The playback speed determination unit 303 shown in FIG. 3 will be described below.

The playback speed determination unit 303 calculates the data lengths of respective acoustic classes included in the audio signal to be played back from the discrimination results obtained by the discrimination unit 302. For example, the unit 303 calculates values like 30 minutes as a data length T_{P} of a speech interval included in the audio signal to be played back, 30 minutes as a data length Tₙ of a non-speech interval, and so forth. The unit 303 then determines the playback speeds of respective audio classes based on these pieces of information, so as to complete playback of the audio signal within the playback required period. Note that the unit 303 acquires the playback required period from the required time estimation apparatus 102 or the like, as described in the first embodiment.

When the playback speed determination unit 303 sets a playback speed Pₙ of the non-speech interval α times (Pₙ=αPₛ) of a playback speed Pₛ of the speech interval, it can calculate the playback speed Pₛ in the speech interval required to complete playback of the audio signal within the playback required period by:

$$\begin{matrix}Y = ( \frac{{T}_{s}}{{P}_{s}} + \frac{{T}_{n}}{{P}_{n}} ) \\ {P}_{s} = ( \frac{{T}_{s}}{Y} + \frac{{T}_{n}}{α Y} )\end{matrix}$$

Note that the value α is desirably set to be equal to or larger than 1.0. As a result, the playback speed of the non-speech interval can be set to be higher than that of the speech interval, and the playback speed of the speech interval including more significant information can be relatively lowered. The playback speeds of the speech and non-speech intervals when α=1.0 and 2.0 are as follows.

$$( α = 1.0 )$$

$${P}_{s} = ( \frac{{T}_{s}}{Y} + \frac{{T}_{n}}{α Y} ) = ( \frac{30}{30} + \frac{30}{1.0 \cdot 30} ) = 2.0 \\ {P}_{n} = α {P}_{s} = 2.0 \\ ( α = 2.0 ) \\ \begin{matrix}{P}_{s} = ( \frac{{T}_{s}}{Y} + \frac{{T}_{n}}{α Y} ) = ( \frac{30}{30} + \frac{30}{2 \cdot 30} ) = 1.5 \\ {P}_{n} = {α P}_{s} = 3.0\end{matrix}$$

Also, control with the value α=∞, i.e., that for practically deleting each non-speech interval can be made.

As another method, the playback speed of either the speech interval or non-speech interval may be determined in advance. For example, when the playback speed Pₙ in the non-speech interval is fixed to a 5.0× speed under the aforementioned condition, the playback speed Pₛ in the speech interval is given by:

$$\begin{matrix}Y = ( \frac{{T}_{s}}{{P}_{s}} + \frac{{T}_{n}}{5.0} ) \\ {P}_{s} = ( \frac{5.0 \cdot {T}_{s}}{5.0 \cdot Y - {T}_{n}} ) = ( \frac{5.0 \cdot 30}{5.0 \cdot 30 - 30} ) = 1.25\end{matrix}$$

As described in the first embodiment, a change per unit time may be controlled to fall within a predetermined range upon switching the playback speeds of respective acoustic classes, or the determined playback speeds of respective acoustic classes may be limited to fall within a predetermined range. In this way, by setting the individual playback speeds for respective acoustic classes, the user can listen to each non-speech interval with a small information volume at higher speed.

Upon listening to an audio signal recorded in a concert, the discrimination unit 302 may discriminate music and non-music intervals to set a low playback speed in a music interval, and a high playback speed in a non-music interval. The music and non-music signals can be discriminated by extracting the energies and the number of zero-crossing points from an input signal, and collating them with standard patterns of music and non-music signals which are learned in advance (see Saunders, Johns., “Real-Time Discrimination of Broadcast Speech/Music”, IEEE ICASSP-96, pages 993-996).

As described above, according to the second embodiment, acoustic classes included in an audio signal are discriminated, and the playback speeds in respective acoustic classes are controlled, thus providing, to the user, a more comfortable listening condition upon completing playback of the audio signal within the playback required period.

According to the aforementioned embodiments, a playback required period of an audio signal to be played back is determined in accordance with an estimated required period acquired from the required time estimation apparatus, which estimates a required period until arrival at a destination based on the current position of an object in motion and the position information of the destination. After that, the playback speed is determined based on the acquired playback required period and the data length of the audio signal, so as to complete playback of the audio signal within the playback required period. In this way, an optimal playback speed can be determined to accomplish the aim of completing playback of the audio signal within the playback required period. Furthermore, since the playback apparatus comprises the discrimination unit which discriminates acoustic classes included in an input audio signal, it can set the playback speeds for respective acoustic classes. For example, the audio signal may be classified into speech and non-speech intervals, and the playback speed is set to be higher in a non-speech interval than that in a speech interval, thus relatively lowering the playback speed in the speech interval. As a result, the listening load on the user can be reduced.

The block diagrams of the embodiments illustrate methods and systems according to the embodiments of the invention. It will be understood that each block of the block diagram illustrations, and combinations of blocks in the block diagram illustrations, can be implemented by computer program instructions. These computer program instructions may be loaded onto a computer or other programmable apparatus to produce a machine, such that the instructions which execute on the computer or other programmable apparatus create means for implementing the functions specified in the block diagram block or blocks. These computer program instructions may also be stored in a computer-readable memory that can direct a computer or other programmable apparatus to function in a particular manner, such that the instruction stored in the computer-readable memory produce an article of manufacture including instruction means which implement the function specified in the block diagram block or blocks. The computer program instructions may also be loaded onto a computer or other programmable apparatus to cause a series of operational steps to be performed on the computer or other programmable apparatus to produce a computer programmable apparatus which provides steps for implementing the functions specified in the block diagram block or blocks.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A playback apparatus used for an audio database comprising:
a first acquisition unit configured to acquire first position information and second position information;
an estimation unit configured to estimate a required period from a first position to a second position based on the first position information and the second position information;
a second acquisition unit configured to acquire a data length of an audio signal to be played back from the audio database;
a determination unit configured to determine a playback speed required to play back the audio signal based on the required period and the data length to complete playback of the audio signal within the required period; and
a playback unit configured to play back the audio signal according to the playback speed.

2. The apparatus according to claim 1, wherein when the required period changes, the determination unit determines a playback speed based on the required period after change and the data length.

3. The apparatus according to claim 1, wherein the determination unit updates the playback speed when the required period changes, and determines the updated playback speed to set a difference between the playback speeds before and after updating that falls within a predetermined range.

4. The apparatus according to claim 1, wherein the determination unit determines a playback speed within a speed range.

5. A playback apparatus used for an audio database comprising:
a first acquisition unit configured to acquire an audio signal to be played back from the audio database;
a discrimination unit configured to discriminate intervals for respective acoustic classes included in the audio signal;
a calculation unit configured to calculate data lengths for respective intervals;
a second acquisition unit configured to acquire first position information and second position information;
an estimation unit configured to estimate a required period from a first position to a second position based on the first position information and the second position information;
a determination unit configured to determine a plurality of playback speeds required to play back the audio signal for respective intervals based on the required period and the data lengths for respective intervals to complete playback of the audio signal within the required period; and
a playback unit configured to play back the audio signal according to the playback speeds.

6. The apparatus according to claim 5, wherein the discrimination unit discriminates a speech interval and a non speech interval of the audio signal, and
the determination unit determines the playback speeds of the speech interval and the non speech interval the playback speed in the non speech interval becoming higher than the playback speed in the speech interval.

7. A playback method comprising:
acquiring first position information and second position information;
estimating a required period from a first position to a second position based on the first position information and the second position information;
acquiring a data length of an audio signal to be played back from an audio database;
determining a playback speed required to play back the audio signal based on the required period and the data length to complete playback of the audio signal within the required period; and
playing back the audio signal according to the playback speed.

8. A playback method comprising:
acquiring an audio signal to be played back from an audio database;
discriminating intervals for respective acoustic classes included in the audio signal;
calculating data lengths for respective intervals;
acquiring first position information and second position information;
estimating a required period from a first position to a second position based on the first position information and the second position information;
determining a plurality of playback speeds required to play back the audio signal for respective intervals based on the required period and the data lengths for respective intervals to complete playback of the audio signal within the required period; and
playing back the audio signal according to the playback speeds.

9. A computer system used for an audio database comprising:
means for acquiring first position information and second position information;
means for estimating a required period from a first position to a second position based on the first position information and the second position information;
means for acquiring a data length of an audio signal to be played back from the audio database;
means for determining a playback speed required to play back the audio signal based on the required period and the data length to complete playback of the audio signal within the required period; and
means for playing back the audio signal according to the playback speed.
